(19) United States
(12) Patent Application Publication
(10) Pub. No.: US 2006/0213073 A1
(43) Pub. Date: Sep. 28, 2006

(54) Static trap

(76) Inventor: David Emma, Providence, RI (US)

Correspondence Address: David Emma, 247 Huxley Avenue, Providence, RI, 02908, US

(21) Appl. No.: 10/999,538

(22) Filed: Mar. 23, 2005

(51) Int. Cl. F26B 19/00; F26B 3/00

(52) U.S. Cl. 34/60; 34/449

(57) ABSTRACT

A static removal apparatus that is placed inside a laundry dryer which contains an assembly of a stainless steel housing plate. Inside the housing are 2 cylinder shaped magnets, a single screw, nut and a stainless steel cap in rear of assembly that is to secure the screw, nut and stainless steel housing plate together. In addition, the rear of the apparatus is open to expose one of the magnets so the device can be attached to the inside face of a laundry dryer door or against the back of the dryer drum.

### BACKGROUND OF INVENTION

During a typical laundry dryer process, the combination of heat, particular material in which clothing is made of develops a friction and in turn, creates static electricity that embodies itself to or inside of the fabric material.

Hence, the Static Trap apparatus sole purpose is to discharge the static by way of a stainless steel encasement (which conducts itself as a safeguard for the clothing away from the magnets and as a filter-through the holes)to filter the force field from the magnets to outside of the encasement to discharge any forming static.

### DESCRIPTION OF THE PREFERRED EMBODIMENTS

Shown in FIG. 1 is to illustrate where the recommended placement in the laundry dryer of the completely assembled apparatus, titled The Static Trap, is to be placed for maximum efficiency for the job it pertains to and also illustrates the only machinery it will coincide with(a residential laundry dryer only).

Inset of FIG. 1 depicts its facing appearance in relation in the FIG. 9 view fill assembly.

In the FIG. 10 illustration is the rear part of the apparatus that is connected to the laundry dryer door as set in relation to FIG. 1.

### BRIEF DESCRIPTION OF DRAWINGS

FIG. 1. Is a picture illustrating where apparatus is placed inside of laundry dryer door.

FIG. 2. Shows a front 3d view of single stainless steel casing which encases FIGS. 3 through 6. Actual size of casing is 3 inches in diameter with a center hole measuring ¾ inches in diameter.

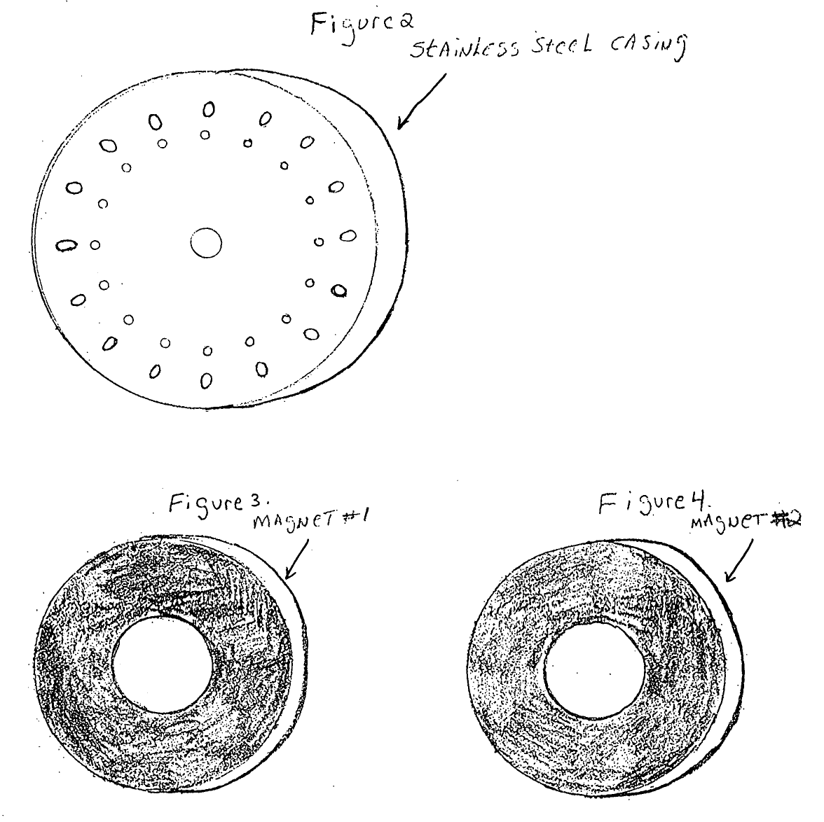

FIG. 3. first illustration of one of 2 circular type magnets. Front view. Actual size is 2¾ inches in diameter. Hole in center of magnet is ¾ inches in diameter. FIG. 4. 2^{nd} illustration of magnet #2 of two circular type magnets. Front view showing. Size of magnet is same as magnet in FIG. 3.

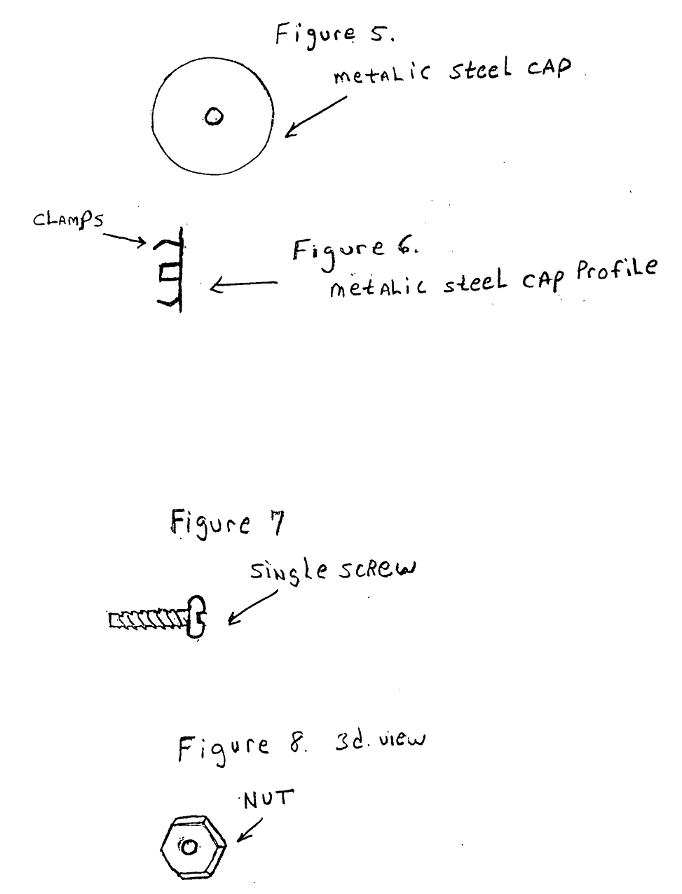

FIG. 5. Shows a front view of metal 1 1/4 inch in diameter steel cap. The hole in center of cap is ¼ inch in diameter-enough room for screw to help cap secure the other components together.

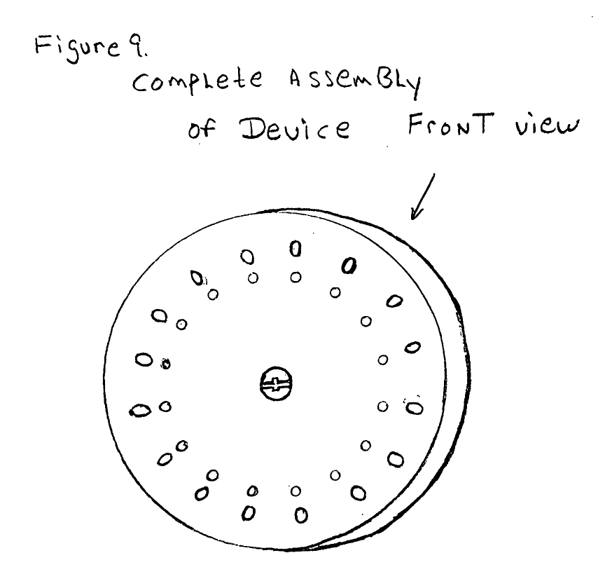

FIG. 6. Illustrates profile view of 1 inch in diameter cap which shows pronged clamps to help cap clamp and fit hole of magnet #2 to secure apparatus.

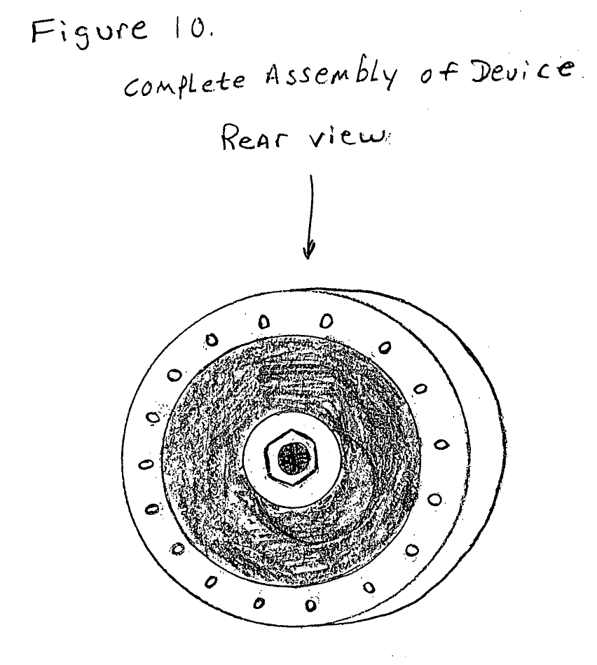

### DESCRIPTION OF DRAWINGS

FIG. 7. Shows side view of single ¾ inch screw. This single part helps connects all parts.

FIG. 8. Shows a ¼ inch in diameter 6 sided nut with hole in middle. This part connects to the screw to completely secure whole apparatus.

FIG. 9. Illustrates a 3d view of complete assembly, including the stainless steel housing with filtering holes around the edge. In the center of device shows the cross pattern which resembles the top of screw head.

FIG. 10. Illustrates rear 3d view of complete assembly(including stainless steel housing) and parts shown in rear of device. As seen are 2^{nd} magnet(shaded) steel cap(in clear color) 6 sided nut and the shaded part in center is the rear end of screw.

What is claimed is:

1. A stainless steel housing encasement for assembly purpose of holding the screw and magnets together and in addition, an added purpose, the holes in the encasing plate act as a filtering process so the magnetic field filters through the encasement to allow the apparatus to discharge the static electricity in the laundry dryer during a typical laundry drying process.
Here in; the particular magnets are the majority element in which static is removed during a drying cycle asides the fact the stainless steel housing has part of affect in the process.

2. The assembly of magnets as set forth in claim 1.
Here in; the inner magnet that is set in the encasement conducts half of the discharging process.

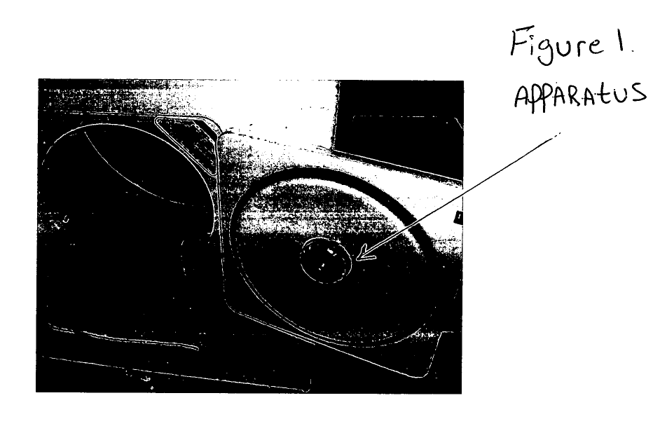

3. The assembly of magnets as set in claim 1 or 2.
Here in; the second magnet exposed in rear of apparatus conducts the other 50% of work in the static removal process. This second magnet is responsible for the attachment of the apparatus to the inside of the metal faced dryer door as shown in FIG. 1.

4. The stainless steel cap assembly helps secure all apparatus parts together, the stainless-steel housing, 2 magnets, one single screw and one nut.

5. A single screw as set in claim 4 helps secure all apparatus parts together.

6. The single nut, as set forth in claim 4, is secured at end of exposed apparatus to complete operation of assembly and hold the device together.
